(19) United States
(12) Patent Application Publication
(10) Pub. No.: US 2025/0245253 A1
(43) Pub. Date: Jul. 31, 2025

(54) SEARCHING PROGRAMMING CODE REPOSITORIES USING LATENT SEMANTIC ANALYSIS

(71) Applicant: Intuit, Inc., Mountain View, CA (US)

(72) Inventors: Sumangal MANDAL, Kolkata (IN); Vaishali GUPTA, New Delhi (IN); Lakshminarayanan SRINIVASAN, Bengaluru (IN); Amit KAUSHAL, Bengaluru (IN)

(21) Appl. No.: 18/429,131

(22) Filed: Jan. 31, 2024

(51) Int. Cl. G06F 16/33; G06F 40/30

(52) U.S. Cl. CPC G06F 16/3344; G06F 40/30

(57) ABSTRACT

Certain aspects of the disclosure are directed to searching programming code repositories. In examples, a method is provided that includes receiving a natural language search query via a graphical user interface; converting the natural language search query into a vector representation; determining a proximity score between the vector representation of the natural language search query and at least one vector representation corresponding to a machine learning model generated natural language description of a programming code segment; and providing a search result corresponding to the programming code segment based on the proximity score.

### BACKGROUND

### Field

Aspects of the present disclosure relate to searching programming code repositories.

### Description of Related Art

Programming code search and discovery is a fundamental part of the software development process. Developers frequently need to locate code segments, functions, libraries, or examples that match a particular task they are working on. However, finding relevant code in large repositories is technically challenging. Codebases contain thousands or even millions of code artifacts, making manual search difficult at best. Existing code search techniques rely primarily on keyword matching, which fails to capture relationships between search terms and code artifacts. For example, a code method named “addNumbers” may be completely unrelated to a search for “sum.” This makes keyword search ineffective for discovering functionally similar code. Developers are left struggling to string together keywords that might return something relevant. Therefore, there is a need for improved techniques enabling effective search and discovery within large programming code repositories.

### SUMMARY

Certain aspects provide a method directed to searching a programming code repository. The method may include receiving a natural language search query via a graphical user interface and converting the natural language search query into a vector representation. The method may further include determining a proximity score between the vector representation of the natural language search query and at least one vector representation corresponding to a machine learning model generated natural language description of a programming code segment; and providing a search result corresponding to the programming code segment based on the proximity score.

Certain aspects provide a method directed to creating searchable programming code repositories. The method may include receiving a programming code segment; generating a first natural language description of the programming code segment using a first prompt input to a machine learning model; generating a first vector representation encoding the first natural language description; generating a second natural language description of the programming code segment using a second prompt input to the machine learning model wherein the second prompt is different from the first prompt; and generating a second vector representation encoding the second natural language description. The method may also include storing the first vector representation and the second vector representation to enable comparison with vector representations of natural language search queries.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a system diagram for searching a programming code repository based on a natural language search query.

FIG. 2 depicts additional details directed to programming code summarization and search processes.

FIGS. 3A-3B depict additional details directed to a programming code summarization and search process that uses multiple prompts to generate multiple natural language descriptions for each programming code segment.

FIG. 4 depicts a search process using vectorized code summaries and a natural language search query to identify relevant code segments.

FIG. 5 depicts a system for performing semantic code search based on natural language queries and code summaries generated from machine learning models.

FIG. 6 provides an overview of an example data structure for enabling natural language search of a programming code repository according to aspects of the present disclosure.

FIG. 7 depicts an example method for searching programming code repositories.

FIG. 8 depicts an example method for creating searchable programming code repositories.

FIG. 9 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for searching programming code repositories using latent semantic analysis techniques.

Advanced code search techniques have attempted to incorporate semantic knowledge through manual annotations, structured comments, metadata tags, and other extra information added to code. However, these approaches place a burden on developers to actively annotate code for the purpose of searching, which may be different from the purpose of code commenting. In addition, the annotations can quickly become out of date as code evolves. Other techniques have leveraged statistical machine learning on various code segments to extract semantic similarities. However, these techniques are limited by the training data and often fail to generalize. That is, the performance of machine learning models is heavily dependent on the quality and quantity of the training data. If the data is insufficient, biased, or noisy, the machine learning model may not learn effectively. Further, machine learning models might fail to generalize when the machine learning model learns the details and noise in the training data to the extent that it negatively impacts the performance on new data or when the machine learning model is applied to data that is significantly different from the training data. For example, machine learning models trained on a curated dataset of code segments and corresponding natural language descriptions may not fully capture the diversity of real-world code. For instance, the training data could be biased towards certain programming languages, code patterns, variable naming conventions, etc. When these trained models are then deployed to summarize a real-world codebase, the new code may use different languages, patterns, conventions, etc. For instance, if the model is trained mainly on Python code, but then needs to process a large Java codebase, it may struggle to properly understand and summarize the Java code. The change in syntax and programming paradigms could negatively impact the model's ability to generalize.

As another example, if training data only includes small code segments while the real application involves summarizing entire classes or modules, the increase in code complexity could exceed what the model learned during training. The extensive details and intricacies of large code components may not match the small examples used for training. In both these cases, the shift from training data to real-world data exposes a model's inability to fully generalize beyond the specifics of what it saw during training. As a result, the performance of semantic code search degrades in practice compared to the original testing results. Overall, existing code search techniques lack the ability to semantically match queries to relevant code segments based on functional similarity rather than just keywords.

Therefore, there is a need for improved techniques for enabling effective automated semantic code search and discovery in code repositories. More capable code search tools relying on robust semantic matching would beneficially enhance developer productivity. Developers could quickly find relevant code examples, implementations, and segments by describing desired functionality in natural language. For example, a developer could simply enter a natural language search prompt, such as “a method that performs addition of two integer numbers and returns the sum” to find a code segment, or method, that performs addition of two integer numbers and returns the sum. To address this need, techniques described herein leverage natural language processing and vector embeddings to enable semantic code search through natural language queries.

More specifically, techniques described herein provide for searching code repositories using natural language search queries to find relevant code segments based on semantic meaning rather than being constrained to keyword matching. Semantic meaning, in programming code, refers to the interpretation of what the programming code is designed to accomplish (e.g., a useful task), independent of its syntactical structure. Unlike syntax, which is governed by the rules of the programming language, semantic meaning refers to understanding the intended behavior, purpose, and outcomes of code segments. That is, the semantic meaning of a code segment includes not just its immediate action, but also its side effects, interactions with other code segments, and its contribution to the overall functionality of the software program under development.

To facilitate searching of modular code components, existing programming code elements such as functions, methods, classes, modules, libraries, scripts, or other reusable code blocks may be summarized into natural language descriptions using machine learning models, such as a Large Language Models (LLM). These modular code components are referred to broadly as ‘code segments’ herein. For example, an individual function or method defined within a codebase can be considered a code segment that can be passed to a machine learning model to generate a natural language summary description. By summarizing code segments in this way, they can be indexed and searched based on semantic meaning rather than just keywords. For each code segment, multiple natural language descriptions can be generated using different natural language summary prompts focused on various aspects of the code segment. An example of a natural language summary prompt may be “explain what the programmer is trying to achieve by the following function.” Another example of a natural language summary prompt may be “explain the significant variables and constants from the following function description.” As another example, an example natural language summary prompt may be “explain what the user would get by using the following function”

The resulting natural language descriptions, or code summaries, received from the machine learning model can then be converted into multi-dimensional vector representations using embedding techniques that preserve semantic relationships in a multi-dimensional latent space. For example, in machine learning and natural language processing, text can be converted into vectors (numerical arrays) using various embedding techniques. Embeddings are a way of translating the semantic meaning of text into a multi-dimensional latent space. Each vector typically consists of several dimensions (alternatively, elements or features), where each dimension represents some aspect of the text's meaning or features. The vector representations are not random, but are structured in a way such that similar meanings or contexts are represented by vectors that are close to each other in the multi-dimensional latent space. That is, by employing one or more embedding techniques, semantic relationships between words can be preserved.

For instance, words with similar meanings can be positioned closer together in the vector space. In the context of code summaries, machine learning model generated natural language descriptions with similar functionalities or concepts can be represented by vectors that are near each other in a multi-dimensional latent space. Preserving semantic relationships in this way allows machine learning models to work with the nuanced meanings embedded in the code summaries and can be applied to various tasks, like code classification, clustering, or even recommendation systems.

In examples described herein, the natural language search queries input by a user are subjected to a similar vectorization process as the code summaries, in order to convert the search queries into vector representations compatible with a shared multi-dimensional latent space. More specifically, a search query vectorizer component can receive a natural language search query string and convert it into a multi-dimensional vector representation encoding the semantic meaning of the query. In examples, the query vectorizer leverages the same embedding techniques used to vectorize the code summaries. Accordingly, matching between query vectors and code summary vectors can be performed using similarity searches in the shared vector space to enable semantic code search based on meaning rather than keywords, thereby improving discovery of relevant code and code reuse. By projecting both the code summaries and search queries into a common multi-dimensional latent space in this manner semantic matching can be performed between the user's search intent, represented by the query vector, and the semantic meaning of code segments encapsulated in the code summary vectors. That is, the relative positioning of the search query vector and code summary vectors in the shared multi-dimensional latent space, and the distances between them, reflect semantic similarities and relationships based on the embedding. This allows matching and retrieval based on meaning rather than keywords or text similarity alone. Further, as described herein, using multiple natural language summary prompts to generate multiple code summaries for each code segment creates a multifaceted representation of code functionality, which can be used to increase the accuracy when identifying code segments based on natural language queries. That is, each natural language summary prompt may focus on different aspects of the code segment, such as functionality, usage, limitations, or design patterns.

### Example System for Searching Programming Code Repositories

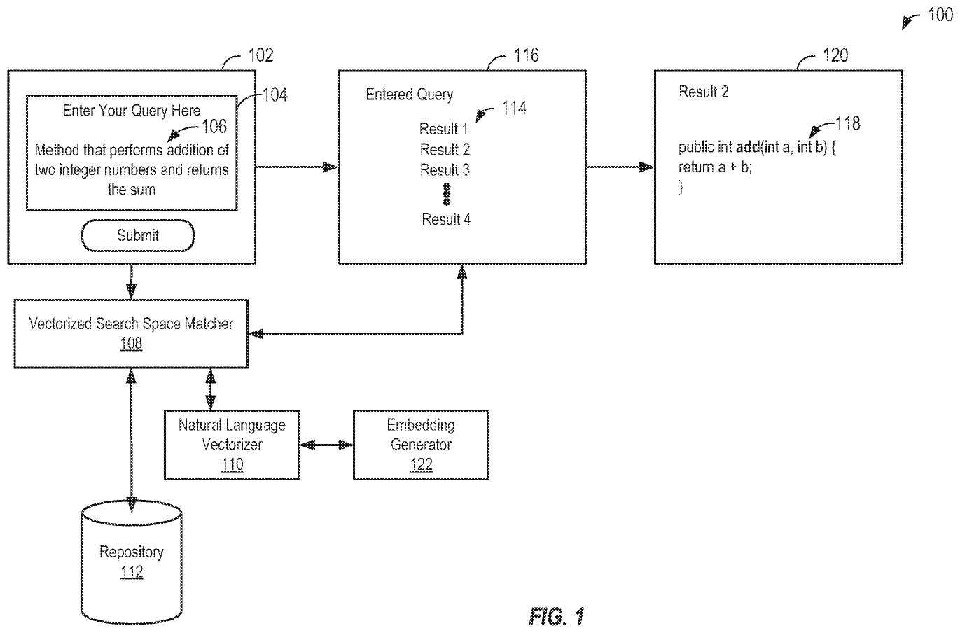

FIG. 1 depicts a high-level system diagram for searching a programming code repository 112 based on a natural language search query 106. The system 100 can include a user interface 102 with a text entry field 104 where a user can enter a natural language search query 106. The natural language search query 106 is then processed by a vectorized search space matcher 108, which converts the natural language search query 106 into a vector representation using a natural language vectorizer 110. The vector representation of the natural language search query 106 can be used to search against vector representations of code segments in the programming code repository 112. Based on matching the vector representation of the natural language search query 106 to one or more vector representations of code segments, the vectorized search space matcher 108 can return search results 114 that can be displayed in a window or user interface 116. In examples, a user can select a search result (e.g., Result 2) to display additional information 118 about a particular code segment in a window or user interface 120. In examples, the code segment could be in one or more programming languages, such as but not limited to, C #, Python, Java, etc.

The natural language vectorizer 110 allows natural language queries, such as the natural language search query 106, to be matched against code segments by converting the queries into embeddings that exist in the shared multi-dimensional latent space as embeddings corresponding to the code segments. That is, the programming code repository 112 contains code elements such as functions, methods, classes, etc. that have been previously summarized by machine learning models into natural language descriptions, as discussed previously. These code summaries are then vectorized into the shared multi-dimensional latent space using the same embedding techniques used by the natural language vectorizer 110.

When a new natural language search query 106 is received by the vectorized search space matcher 108, the natural language vectorizer 110 leverages embedding techniques to project the search query into the same shared multi-dimensional latent space, generating a vector representation encoding the semantic meaning of the query. This allows relevant code segments to be found by searching for the most similar vector representations in the space, with proximity indicating semantic similarity. In some implementations, code segments may be defined for vectorization purposes based on code boundaries and modular components. For example, individual functions, methods, classes, modules, scripts, etc. can form the segments that are summarized and added to the searchable latent space. Alternative segmentation approaches based on tokens, lines, or other attributes are also possible within the scope of the present disclosure. In some examples, the natural language vectorizer 110 can interact with, or otherwise call an API associated with an embedding generator 122. The embedding generator 122 can be a machine learning model configured to generate embeddings, such as but not limited to bidirectional encoder representation from transformers (BERT), contrastive language-image pre-training (CLIP), generative pre-trained transformer (GPT®), etc.

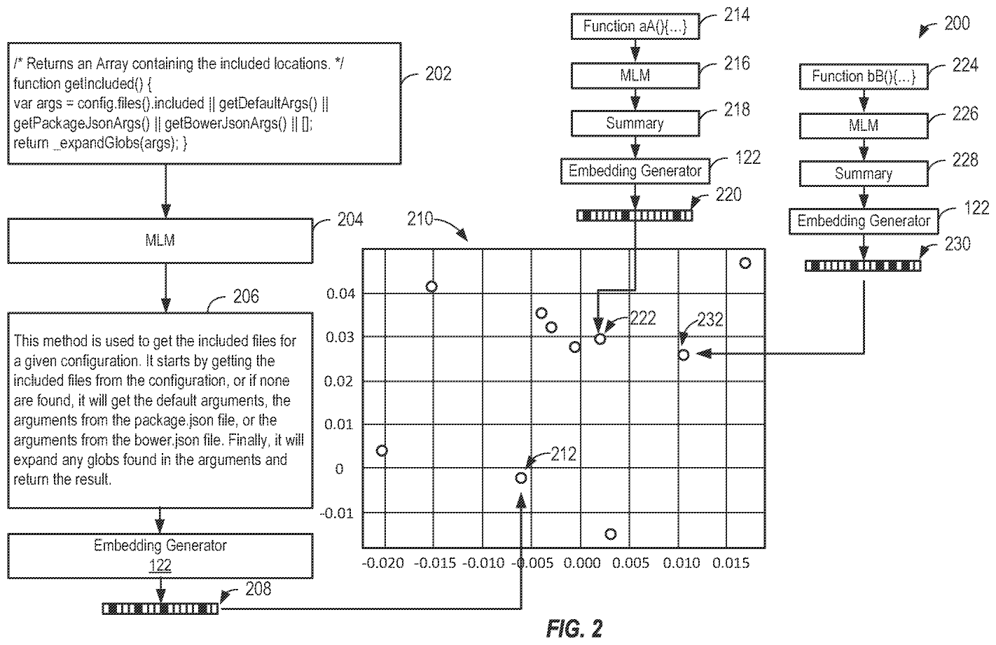

FIG. 2 depicts additional details directed to programming code summarization and search processes 200 in accordance with examples of the present disclosure. More specifically, an individual programming code segment 202, such as a function or method, is passed to a machine learning model (MLM) 204 that summarizes the programming code segment 202 into a natural language description, or summary, 206. The MLM 204 can be an LLM, such as, but not limited to GPT®, BERT, Claude®, Llama, etc. The natural language description, or summary, 206 is then vectorized into an embedding 208. In some examples, a summary vectorizer component, similar to the natural language vectorizer 110, can receive the natural language description, or summary, 206 and interact with, or otherwise call an API associated with an embedding generator, such as the embedding generator 122. For purposes of illustrating the embedding 208 corresponding to the natural language description, or summary, 206 with respect to other embeddings, the embedding 208 is displayed in a vector space 210 where its location 212 represents its position in the vector space 210. While the embedding 208 is depicted in a two-dimensional vector space 210, it should be understood that the embedding 208 can comprise any number of dimensions. This process is repeated for many programming code segments (e.g., programming code segments acquired from a repository, such as GitHub).

For example, a second function 214 corresponding to a programming code segment can be summarized by an MLM 216 into the natural language description, or summary, 218. The MLM 216 can be the same as or different from the MLM 204. The natural language description, or summary, 218 is then vectorized into an embedding 220. In some examples, a summary vectorizer component can receive the natural language description, or summary, 218 and interact with, or otherwise call an API associated with an embedding generator, such as the embedding generator 122. For purposes of illustrating the embedding 220 corresponding to the natural language description, or summary, 218 with respect to other embeddings, the embedding 220 is displayed in a vector space 210 where its location 222 represents its position in the vector space 210. While the embedding 220 is depicted in a two-dimensional vector space 210, it should be understood that the embedding 220 can comprise any number of dimensions.

Different methods or functions are vectorized in the same way after summarization by a MLM into a description and then vectorized into an embedding. As another example, a third function 224 corresponding to a programming code segment can be summarized by an MLM 226 into the natural language description, or summary, 228. The MLM 226 can be the same as or different from the MLM 204 and/or the MLM 216. The natural language description, or summary, 228 is then vectorized into an embedding 230. In some examples, a summary vectorizer component can receive the natural language description, or summary, 228 and interact with, or otherwise call an API associated with an embedding generator, such as the embedding generator 122. For purposes of illustrating the embedding 230 corresponding to the natural language description, or summary, 228 with respect to other embeddings, the embedding 230 is displayed in a vector space 210 where its location 232 represents its position in the vector space 210. While the embedding 230 is depicted in a two-dimensional vector space 210, it should be understood that the embedding 230 can comprise any number of dimensions.

As depicted in FIG. 2, distances calculated between the various embeddings (208, 220, 230) within the vector space 210 can be used to quantify the degree of similarity or dissimilarity among the represented entities or features. These distances, or proximity scores, can be calculated using metrics such as Euclidean distance, cosine similarity, or other appropriate distance measures depending on the specific application and characteristics of the vector space. In some examples, the proximity scores between the vectors can be used to rank the embeddings. Embeddings with vectors closer to one another (lower distance or higher similarity) are ranked higher. Furthermore, the vector space 210 may be structured in such a way that similar embeddings cluster together, facilitating the identification of patterns or groups within the data. This clustering can be leveraged for various applications such as data classification and/or data recommendation, where the proximity of embeddings in the vector space is indicative of underlying relationships or similarities in the data. In addition, the vector space model may be dynamically updated based on new data or feedback, allowing for the continuous refinement and adaptation of the embeddings. This dynamic updating ensures that the vector space remains relevant and accurate over time, reflecting the evolving nature of the data it represents.

In accordance with examples of the present disclosure, an embedding corresponding to a natural language search query, such as the natural language search query 106 (FIG. 1) most closely located to one or more locations 212, 222, 232 of respective embeddings 208, 220, and 230 can be used to determine the most relevant code segment in a repository, such as the programming code repository 112. This determination is based on the proximity of the embedding corresponding to the natural language search query to the predetermined embeddings corresponding to natural language descriptions, or summaries, of existing code segments. The closer the natural language search query embedding is to a particular embedding in the vector space, the higher the relevance or similarity is considered to be. This approach allows for an understanding of the natural language search query input, taking into account not just the literal words used, but also their contextual meaning within a larger dataset. By analyzing the distances and relationships between embeddings, programming code summarization and search processes 200 can infer the intent, sentiment, or underlying message of the natural language search query, leading to more accurately identified and contextually appropriate code segments from the programming code repository 112. Furthermore, as new code segments are added to the code repository, additional natural language summaries can be generated and vectorized into the shared multi-dimensional latent space to continually expand the searchable set of embeddings. This allows the programming code summarization and search processes 200 to stay up to date with a dynamic, evolving codebase, without necessarily requiring further training or modification of the machine learning models themselves.

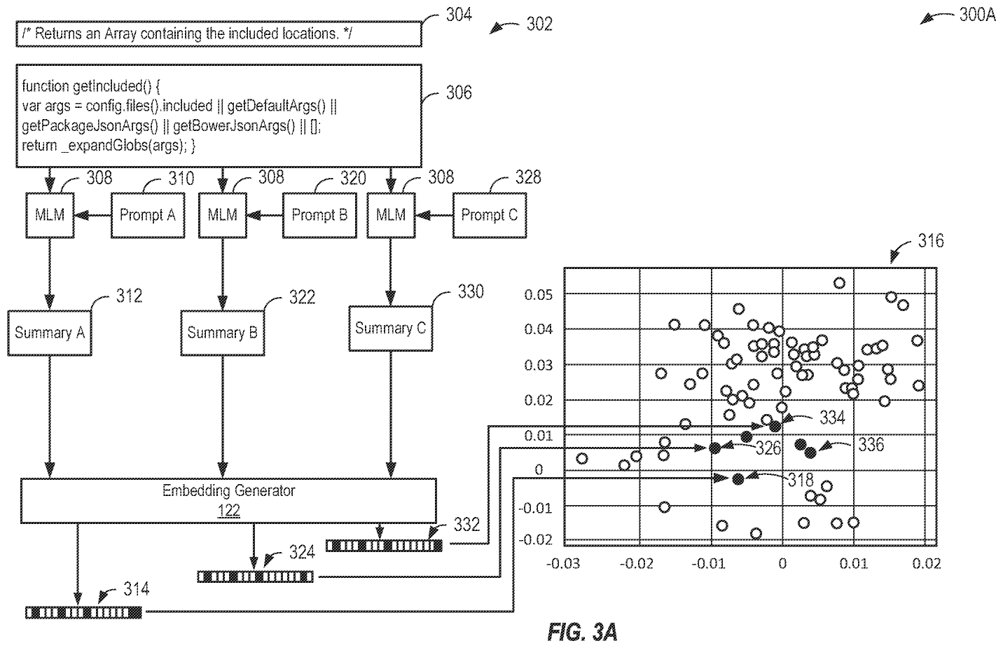

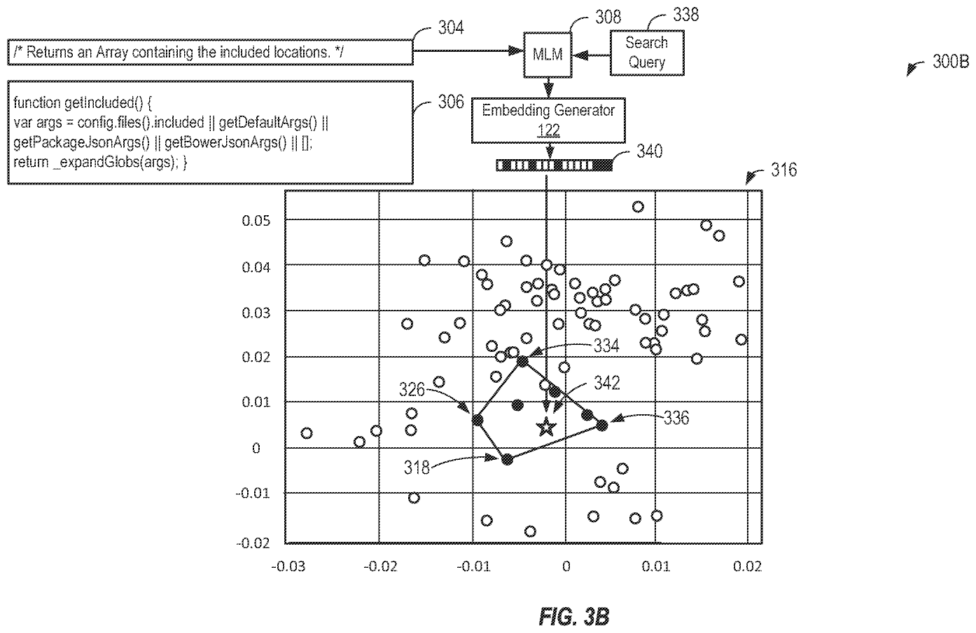

FIG. 3A depicts additional details directed to a programming code summarization and search process 300A that uses multiple prompts to generate multiple natural language descriptions, or summaries, for a single programming code segment. By vectorizing multiple prompt-based summaries, a vector space becomes denser and each programming code segment can be represented from multiple semantic perspectives. Accordingly, compared with a single natural language description, or summary, a search accuracy can be improved. That is, by using different prompt formulations with the MLM, different aspects of the code's functionality can be obtained for searching purposes. By creating embeddings for multiple prompt-based summaries, the vector space becomes multidimensional, with each programming code segment represented as a cluster of points, instead of a single point. This creates a representation of a code segment when using a natural language search query for matching purposes. Even if the natural language search query does not exactly match any single point as indicated by embeddings corresponding to natural language descriptions, or summaries, an embedding corresponding to the natural language search query it is more likely to fall into the cluster representing the relevant code segment.

By leveraging machine learning models and embedding techniques, the system depicted in FIG. 3A provides an efficient and natural way for developers to find relevant code segments based on meaning rather than just keywords. The multiple prompt summarization creates a rich code representation that can match a wide variety of natural language queries in a robust manner. The approach enhances code search, reuse, and discovery by providing an effective tool for programmers searching in codebases of various size.

As depicted in FIG. 3A, a code segment 302 may include user generated text 304 that comprises documentation or comments. In examples, the programming code 306 without the user generated text 304 is passed to the MLM 308. The MLM 308 can be a large language model (LLM) that can generate natural language descriptions of code. Examples of the MLM 308 can include, but are not limited to: include GPT®, BERT, Claude®, Llama, etc. In examples, prompt A 310 is a specific prompt provided to the MLM 308 to generate a natural language description, or summary, focused on a particular aspect of the programming code 306. For example, prompt A 310 can elicit a general description of what the programming code 306 does. The code summary 312 is a natural language description generated by the MLM 308 when provided with prompt A 310 and at least a portion of the code segment 302. In examples, the code summary 312 summarizes the overall functionality of the programming code 306.

The embedding generator 122 (e.g., FIG. 1) generates vector representations of text through embedding techniques. The embedding generator 122 converts the code summaries into vectors. Examples of the embedding generator 122 include BERT, CLIP, etc. The embedding 314 is the vector representation of code summary 312 after being passed through the embedding generator 122. The embedding 314 represents the code summary 312 in the vector space. The location 318 represents the position of the embedding 314 in the vector space 316, where the vector space 316 represents a two-dimensional vector space in this example, but could be any n-dimensional space in other examples. The location 318 depicts the location of the embedding 314 relative to other embeddings, or vectors.

Prompt B 320 is a second prompt provided to the MLM 308 to generate an alternative natural language summary of the code segment 302, focused on a different aspect than the first prompt A 310. For example, prompt B 320 elicits a technical explanation of the code functionality and implementation details. In one example implementation, prompt B 320 is the textual string “explain the technical details of how this code works,” which elicits a summary focused on the code implementation specifics. The code summary 322 then describes the technical details of how the code achieves its functionality, including specifics on the programming logic, data structures, and algorithms used. However, prompt B 320 may be any suitable text string input to MLM 308 to generate a summary, which in some implementations, may be technical in nature. The embedding 324 is the vector representation of the second code summary 322 after being passed through the embedding generator 122. The embedding 324 represents the code summary 322 in a shared vector space. The location 326 represents the position of the embedding 324 in the shared vector space after being plotted in two-dimensions. That is, the location 326 depicts where the embedding 324 for the second code summary 322 is located relative to other vectors, like the embedding 314 corresponding to the first code summary 312 within the shared vector space 316.

Prompt C 328 is a third prompt provided as input to the MLM 308 to generate a third natural language summary of the code segment 302, with a different focus than the first prompt A 310 and second prompt B 320. In one example, prompt C 328 elicits a summary focused on the usage scenario of the code. The code summary 330 is a third natural language description generated as output by MLM 308 when provided with the third prompt C 328 as input and at least a portion of the code segment 302. The code summary 330 can, for example, describe potential use cases and examples of how the code segment 302 may be utilized based on the usage-focused prompt C 328. The third embedding 332 is a third vector representation of the third code summary 330 generated by the embedding generator 122. Third embedding 332 encodes the third code summary 330 into a multidimensional latent vector in the same shared space as embeddings 314 and 324. The location 334 represents the position of the third embedding 332 in the shared vector space after being plotted in two-dimensions. That is, the location 334 depicts where the third embedding 332 for the third code summary 330 is located relative to other vectors, like the embedding 314 corresponding to the first code summary 312 and the embedding 324 corresponding to the second code summary 322 within the shared vector space 316.

The location 336 represents the position of another embedding in the vector space 316 that may correspond to a natural language search query or an embedding for the code segment 302. The relative proximities between location 334 and other locations like 336 in the shared space allows identification of semantically related vectors during a search process.

By generating multiple prompt-based code summaries like code summary 322, the code segment 302 is represented from multiple semantic aspects. This creates a multidimensional cluster of points in the vector space, enabling more robust matching between natural language search queries and relevant code segments. FIG. 3B depicts additional details directed to a programming code summarization and search process 300B that demonstrates semantic code searching using vectorized summaries. The process utilizes a natural language search query to find the most relevant code summary in the shared multi-dimensional latent space. The search query 338 is a natural language search query or other search criteria provided by a user to find a relevant code segment. As an example, the search query 338 could be the text string “find a function that adds two numbers.” The search embedding 340 is a vector representation of the search query 338 generated by the natural language vectorizer, such as the natural language vectorizer 110 in FIG. 1. The search embedding 340 represents the semantic meaning of search query 338 as a multidimensional vector. In examples, the search embedding 340 is generated by the embedding generator 122 as discussed with respect to FIG. 1.

The search embedding location 342 represents the position of search embedding 340 in the shared vector space 316 after being plotted in two-dimensions, however, as above, any number of dimensions may be used. Some dimensionality reduction techniques may be employed in order to allow convenient 2D or 3D visualization while retaining as much semantic meaning as possible. Search process identifies the most relevant code summary vectors that are closest to search embedding location 342, based on semantic similarity. By converting natural language search queries into vector representations within the shared vector space (e.g., 316), code segments can be discovered based on semantic relevance rather than just keywords. The proximity between the search embedding 340 and code summary embeddings indicates semantically related segments, as illustrated by search process 300B. The proximity between the search embedding 340 and code summary embeddings can be measured using a distance metric. Common metrics include Euclidean distance and cosine similarity. After calculating the proximity scores between the search embedding 340 and other code summary embeddings, the proximity scores can be used to rank the code summary embeddings. Code summary embeddings closer to the search embedding 340 (lower distance or higher similarity) can be ranked higher. The polygon visualized in the 2D plot of FIG. 3B connects the points of the closest, most relevant code summary embeddings to the search embedding, creating a bounded area indicating the code segments determined to have the highest semantic similarity. In the full shared multi-dimensional latent space, this would equate to a volume enclosing the most relevant points.

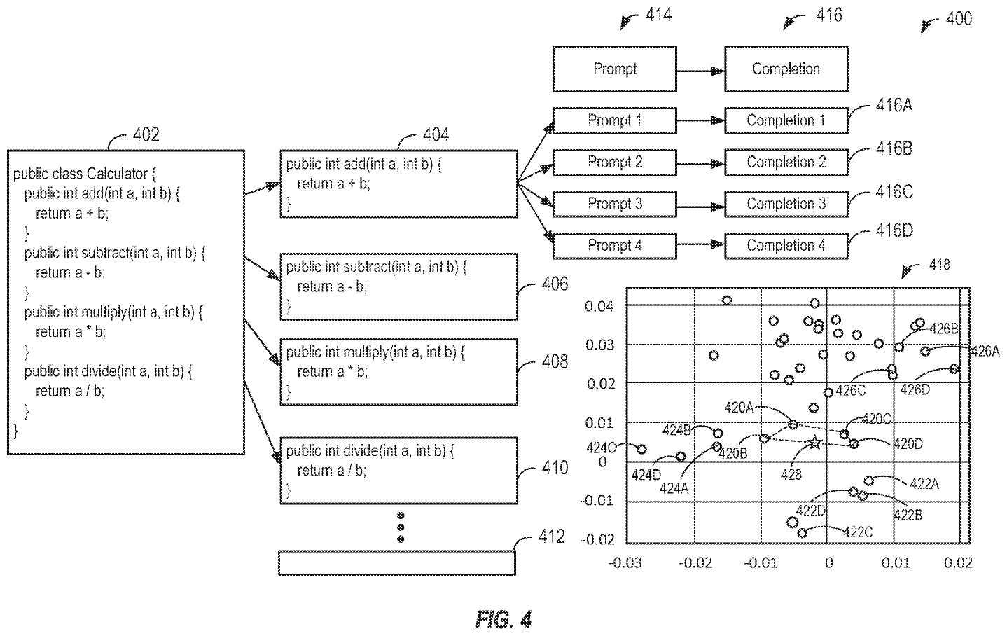

FIG. 4 depicts a search process using vectorized code summaries and a natural language search query to identify relevant code segments. In one example, code segment 402 contains multiple functions including a first function 404, second function 406, third function 408, and fourth function 410. Additional functions beyond 404-410 may also be present, as represented by reference character 412.

For each function 404, 406, 408, 410, 412 etc., a code summarization process generates multiple natural language code summaries 416 based on different prompts 414 supplied to a machine learning model, such as a large language model (e.g., MLM 308 of FIG. 3). These code summaries describe each function (e.g., 404, 406, 408, 410, or 412) from various semantic aspects focused on functionality, usage scenarios, limitations, technical implementation details, etc. Code summaries 416A-416D represent multiple natural language descriptions of a first code segment, generated by the machine learning model based on respective prompts. For example, 416A may be a functional overview, 416B may be a technical explanation, 416C may describe usage scenarios, and 416D may summarize limitations.

Vectorized embedding locations 420A-D, 422A-D, 424A-D, 426A-D, etc. represent the converted vector positions of the multiple summaries 416A-416D associated with each code function 404-410. Together, the vectors, or embeddings, form multi-dimensional clusters enabling a type of semantic comparison to vectorized natural language search queries for identifying relevant code. Embedding locations 420A-420D represent the vectorized positions in the latent space of code summaries 416A-416D respectively. Locations 420A-420D form a cluster associated with the first function 404. Similarly, embedding locations 422A-422D represent vectorized positions of multiple summaries generated for a second function 406 using various prompts. Locations 422A-422D form a vector cluster for the second function 406. Embedding locations 424A-424D represent vectorized positions of multiple summaries generated for a third function 408 using various prompts. Locations 424A-424D form a vector cluster for the third function 408. Embedding locations 426A-426D represent vectorized positions of multiple summaries generated for a fourth function 410 using various prompts. Locations 426A-426D form a vector cluster for the fourth function 410. Location 428 represents a vectorized search query embedding plotted in the shared latent space 418. The search process matches this location to the nearest code segment cluster, such as cluster 420A-420D.

As discussed above, the multiple vectorized embeddings for each code segment (e.g. 420A-420D for the first function 404) can be mathematically grouped into clusters. One approach is to calculate a central vector or centroid point that represents the arithmetically averaged position of all the code segment's associated embeddings. This centroid point serves as the cluster center. Additionally, a cluster radius threshold can be defined to delineate the bounds of the cluster. For example, all points within a defined Euclidean distance of the cluster center may be considered part of that cluster. The combination of the cluster center and radius delineates a specific region or volume within the multi-dimensional latent space. This defined area contains embeddings that are identified as being relevant to a particular code segment. When a search query embedding (e.g. 428) is vectorized, relevant code clusters can be identified as those where the search vector falls within the defined cluster boundary. That is, when the centroid and radius model is used for cluster determination, if the Euclidean distance between the search vector and a cluster center is less than the radius threshold, that code segment is considered a match. Defining clusters in this way facilitates similarity-based search and retrieval even when multiple varying embedding points represent a single code segment.

In this manner, multiple prompt-directed summarizations for a function (e.g., 404) creates different semantic representations that may better match a natural language search query provided to the search process. That is, based on semantic similarity assessments made using proximity comparisons of vectorizations of natural language queries to vectorizations of code summaries created by MLMs, those summaries most semantically similar to the natural language search query can be identified and returned to a searcher.

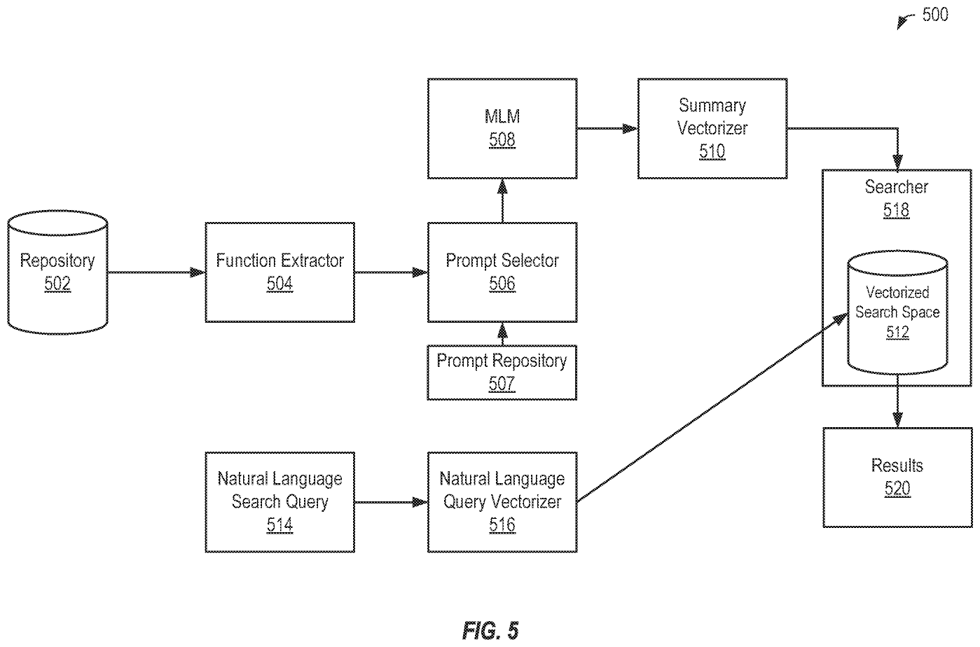

FIG. 5 depicts a system 500 for performing semantic code search based on natural language queries and code summaries generated from machine learning models. The code repository 502 includes programming code, such as functions, methods, modules, libraries, and scripts, which have been previously stored. Code repository 502 serves as a corpus to be searched based on semantic similarity. The function extractor 504 preprocesses programming code in the code repository 502 to extract individual functions, methods, or other modular code segments to be vectorized and stored. The prompt selector 506 determines appropriate prompts to be provided to the MLM 508 to generate multidimensional summary representations of each code segment from different semantic aspects. In some examples, a prompt repository 507 contains a database of predefined prompt templates focused on various semantic facets like functionality, limitations, usage scenarios etc. Thus, the prompt selector 506 can select appropriate prompts from the prompt repository 507. In some examples, the prompt selector 506 can select appropriate prompts from the prompt repository 507 to obtain a specified vector cluster of a specific size (e.g., area) and/or location within a shared semantic space. In some examples, one or more prompts from the prompt repository 507 may be selected to obtain a specified vector cluster based on a location of an embedding or vector created for user generated text or comments (e.g., 304 of FIG. 3A).

The MLM 508 obtains code segments from the code repository 502 and prompts from the prompt selector 506 to generate natural language summaries of the code from different semantic perspectives based on the prompts. The MLM 508 can be a large language model like GPT-3®, BERT, Llama, or Claude® for example. By extracting code segments, selecting semantic prompts, and generating prompt-based summaries, the system 500 creates a multidimensional vector representation of the codebase for performing semantic search based on natural language queries.

The summary vectorizer 510 converts the natural language summaries generated by the MLM 508 into vector representations using embedding techniques. This encodes the semantic meaning of each summary into a multidimensional latent space. Thus, the vectorized search space 512 comprises the collection of vectorized code summaries generated from the code repository 502. This serves as the searchable repository that is queried based on semantic similarity to natural language search queries.

The natural language search query 514 represents a search query provided by a user to find a relevant code segment based on functional requirements or other criteria. The natural language search query 514 can be a textual string describing desired code or functional behavior. The natural language query vectorizer 516 converts the natural language search query 514 into a multidimensional vector representation using similar embedding techniques as the summary vectorizer 510. This embeds the semantic meaning of the search query into a shared latent space. The search results 520, provided by a searcher 518, comprise the most relevant code segments from the code repository 502 identified based on semantic similarity between the natural language search vector obtained from the natural language query vectorizer 516 and the code summary vectors from the summary vectorizer 510 in the shared latent space. The closest summary vectors indicate the most relevant code. By vectorizing both the codebase summaries and search queries, the system 500 enables semantic matching based on natural language searches in order to return the most relevant code segments as search results.

### Example Data Structure for Enabling Natural Language Search of a Programming Code Repository

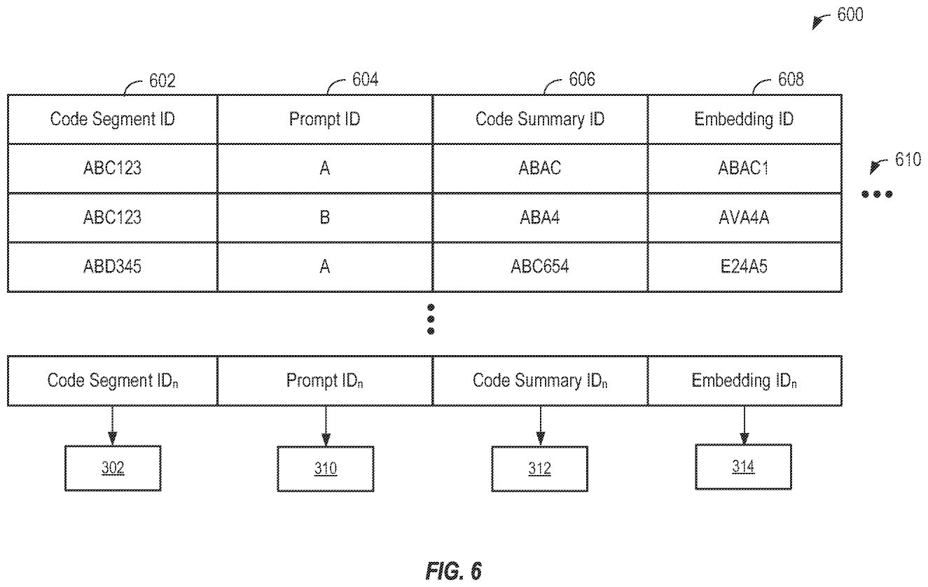

FIG. 6 provides an overview of an example data structure 600 for enabling natural language search of a programming code repository according to aspects of the present disclosure. The data structure 600 includes a code segment identifier 602 that uniquely identifies a code segment, such as a method or function. Each code segment 602 has an associated prompt identifier 604 that identifies the prompt used to generate a natural language summary of the code segment. A code summary identifier 606 then uniquely identifies the specific natural language summary generated for the code segment based on the specified prompt. Finally, an embedding identifier 608 identifies the specific vectorized embedding representation generated from the natural language summary. As a more specific example, the code segment identifier can point to or otherwise reference a particular code segment, such as the code segment 302, the prompt identifier can point to or otherwise reference a particular prompt, such as a prompt 310, the code summary identifier can point to or otherwise reference a summarized code segment, such as code summary 312, and the embedding identifier can point to or otherwise reference a particular embedding, such as embedding 314.

In some examples, the data structure 600 may also include additional data 610 associated with each code segment. This additional data 610 may include metadata such as programming language, code complexity metrics, usage statistics, authorship information, or other relevant data that may be useful for code analysis, prioritization, recommendation, or other applications.

Together, these data fields enable linking between original code segments, the prompts used to summarize them, the resulting text summaries, and the vector embeddings generated from those summaries. Accordingly, impacted vector representations can be updated when changes are made to the underlying code. The data structure 600 facilitates semantic code search by maintaining these relationships between code, prompts, summaries, and embeddings.

### Example Method for Searching Programming Code Repositories

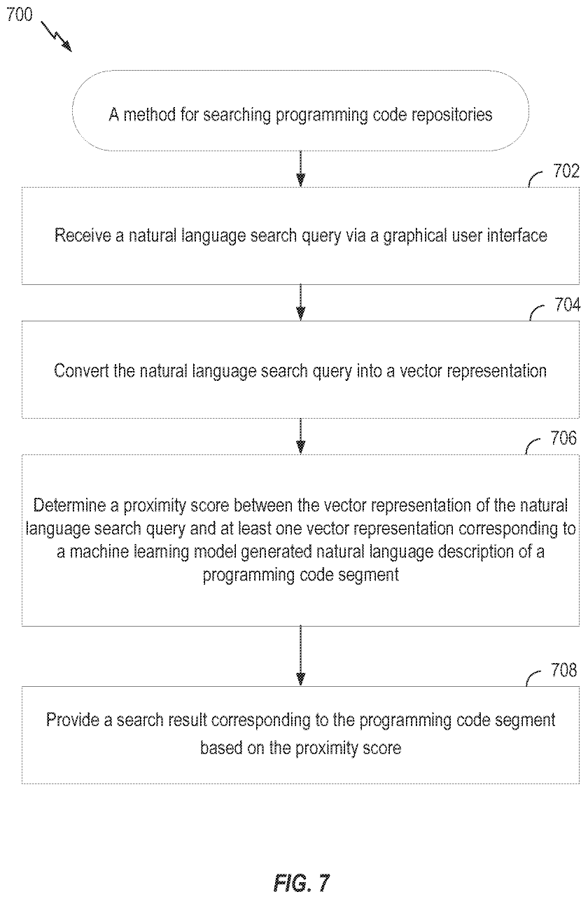

FIG. 7 depicts an example method of searching programming code repositories. In one aspect, method 700 can be implemented by the system 100, 500, and/or 900 for performing semantic code search based on natural language queries and code summaries generated from machine learning models of FIG. 5.

Method 700 starts at block 702 with receiving a natural language search query via a graphical user interface.

The method 700 continues to block 704 with converting the natural language search query into a vector representation.

The method 700 continues to block 706 with determining a proximity score between the vector representation of the natural language search query and at least one vector representation corresponding to a machine learning model generated natural language description of a programming code segment.

The method 700 continues to block 708 with providing a search result corresponding to the programming code segment based on the proximity score.

In some embodiments of the method 700, determining the proximity score between the vector representation of the natural language search query and the at least one vector representation corresponding to the machine learning model generated natural language description of the programming code segment comprises applying a similarity metric between the vector representation of the natural language search query and the at least one vector representation corresponding to the machine learning model generated natural language description of the programming code segment.

In some embodiments of the method 700, the similarity metric comprises a cosine similarity measure.

In some embodiments, method 700 further includes identifying one or more relevant programming code segments based on respective proximity scores between the vector representation of the natural language search query and vector representations corresponding to machine learning model generated natural language descriptions of programming code segments; and ranking the identified one or more relevant programming code segments based on the respective proximity scores, wherein providing the search result comprises displaying ranked one or more relevant programming code segments.

In some embodiments of method 700, a machine learning model uses a first prompt and a second prompt, different from the first prompt, to generate respective first and second natural language descriptions of the programming code segment, wherein a first vector representation encoding the first natural language description and a second vector representation encoding the second natural language description are stored and accessible to enable determining the proximity score between the vector representation of the natural language search query.

In some embodiments, the first prompt focuses on a first semantic aspect of the programming code segment and the second prompt focuses on a second semantic aspect of the programming code segment.

Note that FIG. 7 is just one example of a method, and other methods including fewer, additional, or alternative steps are possible consistent with this disclosure.

### Example Method for Creating Searchable Programming Code Repositories.

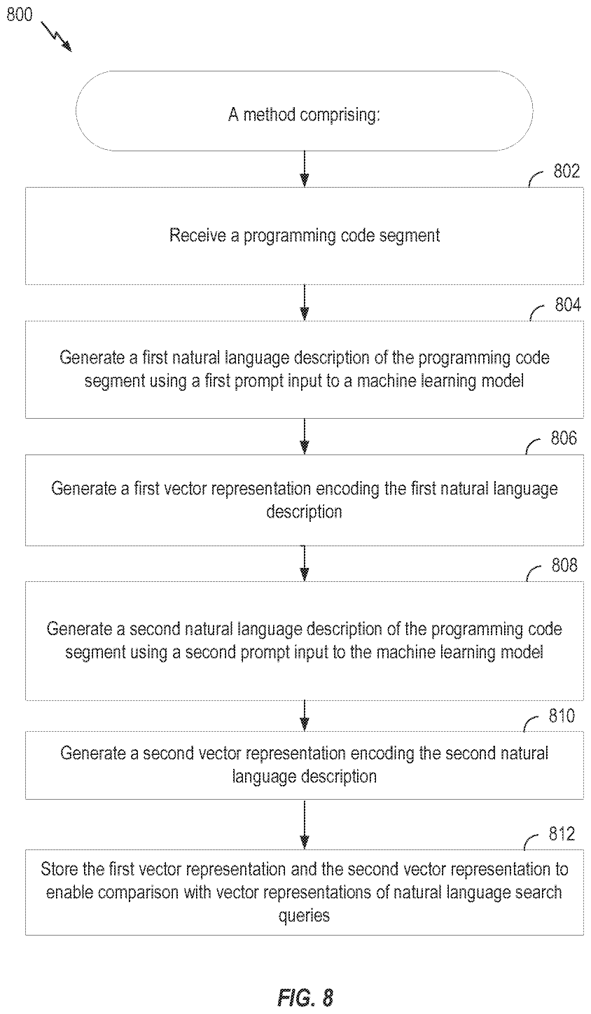

FIG. 8 depicts an example method creating searchable programming code repositories. In one aspect, method 800 can be implemented by the system 100, 500, and/or 900 for performing semantic code search based on natural language queries and code summaries generated from machine learning models of FIG. 5.

Method 800 starts at block 802 with receiving a programming code segment.

The method 800 continues to block 804 with generating a first natural language description of the programming code segment using a first prompt input to a machine learning model.

The method 800 continues to block 806 with generating a first vector representation encoding the first natural language description.

The method 800 continues to block 808 with generating a second natural language description of the programming code segment using a second prompt input to the machine learning model, wherein the second prompt is different from the first prompt.

The method 800 continues to block 810 with generating a second vector representation encoding the second natural language description.

The method 800 continues to block 812 with storing the first vector representation and the second vector representation to enable comparison with vector representations of natural language search queries.

In some embodiments, method 800 further includes receiving a natural language search query; generating a vector representation of the natural language search query; and comparing the vector representation of the natural language search query to the stored first vector representation and the stored second vector representation based on proximity scores to identify relevant code segments. In some embodiments, comparing the vector representation of the natural language search query to identify relevant code segments comprises: calculating proximity scores between the vector representation of the search query and stored vector representations; and ranking identified programming code segments based on the proximity scores. In some embodiments, method 800 further includes providing search results comprising the ranked identified programming code segments. In some embodiments, the proximity scores are based on a cosine similarity measure.

In some embodiments of method 800, the first prompt is directed to a first semantic aspect of the programming code segment and the second prompt is directed to a second semantic aspect of the code segment.

In some embodiments of method 800, the code segment is a function extracted from a method, the method including a plurality of functions.

In some embodiments of method 800, storing the first and second vector representations comprises storing the vector representation in a structure to enable comparison with the vector representations of natural language search queries.

Note that FIG. 8 is just one example of a method, and other methods including fewer, additional, or alternative steps are possible consistent with this disclosure.

### Example Processing System for Searching Programming Code Repositories

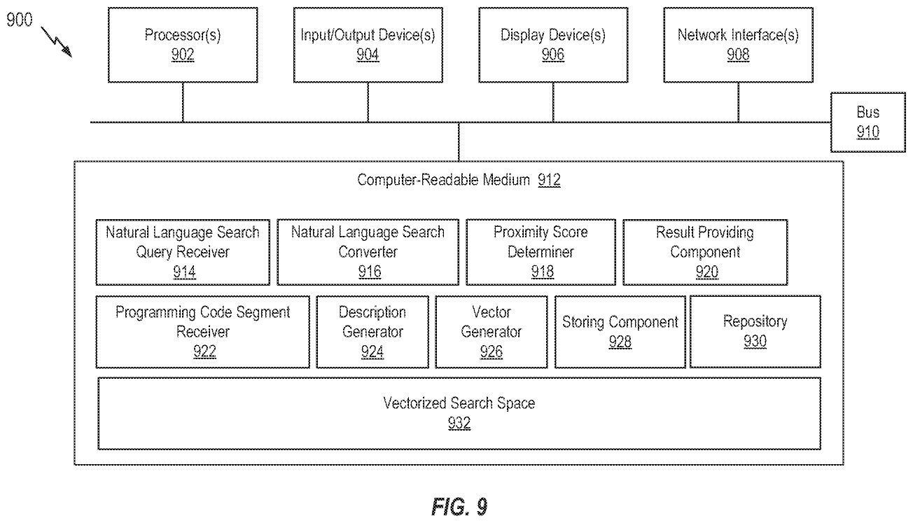

FIG. 9 depicts an example processing system 900 configured to perform various aspects described herein, including, for example, methods 700 and 800 as described above with respect to FIGS. 7-8.

Processing system 900 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 900 includes one or more processors 902, one or more input/output devices 904, one or more display devices 906, one or more network interfaces 908 through which processing system 900 is connected to one or more networks (e.g., a local network, an intranet, the Internet, or any other group of processing systems communicatively connected to each other), and computer-readable medium 912. In the depicted example, the aforementioned components are coupled by a bus 910, which may generally be configured for data exchange amongst the components. Bus 910 may be representative of multiple buses, while only one is depicted for simplicity.

Processor(s) 902 are generally configured to retrieve and execute instructions stored in one or more memories, including local memories like computer-readable medium 912, as well as remote memories and data stores. Similarly, processor(s) 902 are configured to store application data residing in local memories like the computer-readable medium 912, as well as remote memories and data stores. More generally, bus 910 is configured to transmit programming instructions and application data among the processor(s) 902, display device(s) 906, network interface(s) 908, and/or computer-readable medium 912. In certain embodiments, processor(s) 902 are representative of a one or more central processing units (CPUs), graphics processing unit (GPUs), tensor processing unit (TPUs), accelerators, and other processing devices.

Input/output device(s) 904 may include any device, mechanism, system, interactive display, and/or various other hardware and software components for communicating information between processing system 900 and a user of processing system 900. For example, input/output device(s) 904 may include input hardware, such as a keyboard, touch screen, button, microphone, speaker, and/or other device for receiving inputs from the user and sending outputs to the user.

Display device(s) 906 may generally include any sort of device configured to display data, information, graphics, user interface elements, and the like to a user. For example, display device(s) 906 may include internal and external displays such as an internal display of a tablet computer or an external display for a server computer or a projector. Display device(s) 906 may further include displays for devices, such as augmented, virtual, and/or extended reality devices. In various embodiments, display device(s) 906 may be configured to display a graphical user interface.

Network interface(s) 908 provide processing system 900 with access to external networks and thereby to external processing systems. Network interface(s) 908 can generally be any hardware and/or software capable of transmitting and/or receiving data via a wired or wireless network connection. Accordingly, network interface(s) 908 can include a communication transceiver for sending and/or receiving any wired and/or wireless communication.

Computer-readable medium 912 may be a volatile memory, such as a random access memory (RAM), or a nonvolatile memory, such as nonvolatile random access memory (NVRAM), or the like. In this example, computer-readable medium 912 includes a natural language search query receiver 914, a natural language search converter 916, a proximity score determiner 918, a result providing component 920, a programming code segment receiver 922, a description generator 924, a vector generator 926, a storing component 928, a repository 930, and a vectorized search space 932.

In certain embodiments, the natural language search query receiver 914 is configured to receive a natural language search query via a graphical user interface. In certain embodiments, natural language search converter 916 is configured to convert the natural language search query into a vector representation. In certain embodiments, proximity score determining 918 is configured to determine a proximity score between the vector representation of the natural language search query and at least one vector representation corresponding to a machine learning model generated natural language description of a programming code segment. In some embodiments, result providing component 920 is configured to provide a search result corresponding to the programming code segment based on the comparison.

In certain embodiments, programming code segment receiver 922 is configured to receive a programming code segment. In certain embodiments, description generator 924 is configured to generate first natural language description of the programming code segment using a first prompt input to a machine learning model and generate a second natural language description of the programming code segment using a second prompt, different than the first prompt, input to the machine learning model. In certain embodiments, vector generator 926 is configured to generate a first vector representation encoding the first natural language description and generate a second vector representation encoding the second natural language description. In some embodiments, component 928 is configured to store the first vector representation and the second vector representation to enable comparison with vector representations of natural language search queries. The repository 930 may be the same as or similar to the programming code repository 112 (FIG. 1) and/or code repository 502 (FIG. 5). The search space 932 may be the same as or similar to search space 512 (FIG. 5).

Note that FIG. 9 is just one example of a processing system consistent with aspects described herein, and other processing systems having additional, alternative, or fewer components are possible consistent with this disclosure.

### Example Clauses

Implementation examples are described in the following numbered clauses:

Clause 1: A method comprising: receiving a natural language search query via a graphical user interface; converting the natural language search query into a vector representation; determining a proximity score between the vector representation of the natural language search query and at least one vector representation corresponding to a machine learning model generated natural language description of a programming code segment; and providing a search result corresponding to the programming code segment based on the proximity score.

Clause 2: The method of Clause 1, wherein determining the proximity score between the vector representation of the natural language search query and the at least one vector representation corresponding to the machine learning model generated natural language description of the programming code segment comprises applying a similarity metric between the vector representation of the natural language search query and the at least one vector representation corresponding to the machine learning model generated natural language description of the programming code segment.

Clause 3: The method of Clause 2, wherein the similarity metric comprises a cosine similarity measure.

Clause 4: The method of any one of Clauses 1-3, further comprising: identifying one or more relevant programming code segments based on respective proximity scores between the vector representation of the natural language search query and vector representations corresponding to machine learning model generated natural language descriptions of programming code segments; and ranking the identified one or more relevant programming code segments based on the respective proximity scores, wherein providing the search result comprises displaying ranked one or more relevant programming code segments.

Clause 5: The method of any one of Clauses 1-4, wherein a machine learning model uses a first prompt and a second prompt, different from the first prompt, to generate respective first and second natural language descriptions of the programming code segment, wherein a first vector representation encoding the first natural language description and a second vector representation encoding the second natural language description are stored and accessible to enable determining the proximity score between the vector representation of the natural language search query.

Clause 6: The method of Clause 5, wherein the first prompt focuses on a first semantic aspect of the programming code segment and the second prompt focuses on a second semantic aspect of the programming code segment.

Clause 7: A method comprising: receiving a programming code segment; generating a first natural language description of the programming code segment using a first prompt input to a machine learning model; generating a first vector representation encoding the first natural language description; generating a second natural language description of the programming code segment using a second prompt input to the machine learning model wherein the second prompt is different from the first prompt; generating a second vector representation encoding the second natural language description; and storing the first vector representation and the second vector representation to enable comparison with vector representations of natural language search queries.

Clause 8: The method of Clause 7, further comprising: receiving a natural language search query; generating a vector representation of the natural language search query; and comparing the vector representation of the natural language search query to the stored first vector representation and the stored second vector representation based on proximity scores to identify relevant code segments.

Clause 9: The method of Clause 8, wherein comparing the vector representation of the natural language search query to identify relevant code segments comprises: calculating proximity scores between the vector representation of the search query and stored vector representations; and ranking identified programming code segments based on the proximity scores.

Clause 10: The method of Clause 9, further comprising providing search results comprising the ranked identified programming code segments.

Clause 11: The method of any one of Clauses 9-10, wherein the proximity scores are based on a cosine similarity measure.

Clause 12: The method of any one of Clauses 7-11, wherein the first prompt is directed to a first semantic aspect of the programming code segment and the second prompt is directed to a second semantic aspect of the code segment.

Clause 13: The method of any one of Clauses 7-12, wherein the code segment is a function extracted from a method, the method including a plurality of functions.

Clause 14: The method of any one of Clauses 7-13, wherein storing the first and second vector representations comprises storing the vector representation in a structure to enable comparison with the vector representations of natural language search queries.

Clause 15: A processing system, comprising: a memory comprising computer-executable instructions; and a processor configured to execute the computer-executable instructions and cause the processing system to perform a method in accordance with any one of Clauses 1-14.

Clause 16: A processing system, comprising means for performing a method in accordance with any one of Clauses 1-14.

Clause 17: A non-transitory computer-readable medium storing program code for causing a processing system to perform the steps of any one of Clauses 1-14.

Clause 18: A computer program product embodied on a computer-readable storage medium comprising code for performing a method in accordance with any one of Clauses 1-14.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method comprising:
receiving a natural language search query via a graphical user interface;
converting the natural language search query into a vector representation;
determining a proximity score between the vector representation of the natural language search query and at least one vector representation corresponding to a machine learning model generated natural language description of a programming code segment; and
providing a search result corresponding to the programming code segment based on the proximity score.

2. The method of claim 1, wherein determining the proximity score between the vector representation of the natural language search query and the at least one vector representation corresponding to the machine learning model generated natural language description of the programming code segment comprises applying a similarity metric between the vector representation of the natural language search query and the at least one vector representation corresponding to the machine learning model generated natural language description of the programming code segment.

3. The method of claim 2, wherein the similarity metric comprises a cosine similarity measure.

4. The method of claim 1, further comprising:
identifying one or more relevant programming code segments based on respective proximity scores between the vector representation of the natural language search query and vector representations corresponding to machine learning model generated natural language descriptions of programming code segments; and
ranking the identified one or more relevant programming code segments based on the respective proximity scores, wherein providing the search result comprises displaying ranked one or more relevant programming code segments.

5. The method of claim 1, wherein a machine learning model uses a first prompt and a second prompt, different from the first prompt, to generate respective first and second natural language descriptions of the programming code segment, wherein a first vector representation encoding the first natural language description and a second vector representation encoding the second natural language description are stored and accessible to enable determining the proximity score between the vector representation of the natural language search query.

6. The method of claim 5, wherein the first prompt focuses on a first semantic aspect of the programming code segment and the second prompt focuses on a second semantic aspect of the programming code segment.

7. A processing system, comprising:
a memory comprising computer-executable instructions; and
a processor configured to execute the computer-executable instructions and cause the processing system to:
receive a natural language search query via a graphical user interface;
convert the natural language search query into a vector representation;
determine a proximity score between the vector representation of the natural language search query and at least one vector representation corresponding to a machine learning model generated natural language description of a programming code segment; and
provide a search result corresponding to the programming code segment based on the proximity score.

8. The processing system of claim 7, wherein determining the proximity score between the vector representation of the natural language search query and the at least one vector representation corresponding to the machine learning model generated natural language description of the programming code segment comprises applying a similarity metric between the vector representation of the natural language search query and the at least one vector representation corresponding to the machine learning model generated natural language description of the programming code segment.

9. The processing system of claim 8, wherein the similarity metric comprises a cosine similarity measure.

10. The processing system of claim 7, wherein the processor is further configured to cause the processing system to:
identify one or more relevant programming code segments based on respective proximity scores between the vector representation of the natural language search query and vector representations corresponding to machine learning model generated natural language descriptions of programming code segments; and
rank the identified programming code segments based on the respective proximity scores, wherein providing the search result comprises displaying ranked identified programming code segments.

11. The processing system of claim 7, wherein a machine learning model uses a first prompt and a second prompt, different from the first prompt, to generate respective first and second natural language descriptions of the programming code segment, wherein a first vector representation encoding the first natural language description and a second vector representation encoding the second natural language description are stored and accessible to enable determination of the proximity score between the vector representation of the natural language search.

12. The processing system of claim 11, wherein the first prompt focuses on a first semantic aspect of the code segment and the second prompt focuses on a second semantic aspect of the code segment.

13. A method, comprising:
receiving a programming code segment;
generating a first natural language description of the programming code segment using a first prompt input to a machine learning model;
generating a first vector representation encoding the first natural language description;
generating a second natural language description of the programming code segment using a second prompt input to the machine learning model wherein the second prompt is different from the first prompt;
generating a second vector representation encoding the second natural language description; and
storing the first vector representation and the second vector representation to enable comparison with vector representations of natural language search queries.

14. The method of claim 13, further comprising:
receiving a natural language search query;
generating a vector representation of the natural language search query; and
comparing the vector representation of the natural language search query to the stored first vector representation and the stored second vector representation based on proximity scores to identify relevant code segments.

15. The method of claim 14, wherein comparing the vector representation of the natural language search query to identify relevant code segments comprises:
calculating proximity scores between the vector representation of the search query and stored vector representations; and
ranking identified programming code segments based on the proximity scores.

16. The method of claim 15, further comprising providing search results comprising the ranked identified programming code segments.

17. The method of claim 15, wherein the proximity scores are based on a cosine similarity measure.

18. The method of claim 13, wherein the first prompt is directed to a first semantic aspect of the programming code segment and the second prompt is directed to a second semantic aspect of the code segment.

19. The method of claim 13, wherein the code segment is a function extracted from a method, the method including a plurality of functions.

20. The method of claim 13, wherein storing the first and second vector representations comprises storing the vector representation in a structure to enable comparison with the vector representations of natural language search queries.
